(19) United States
(12) Patent Application Publication
(10) Pub. No.: US 2025/0225275 A1
(43) Pub. Date: Jul. 10, 2025

(54) PRIVACY CONTROL OF IMAGES BASED ON CONTENT

(71) Applicant: QUALCOMM Incorporated, San Diego, CA (US)

(72) Inventors: Qimeng PAN, Shenzhen (CN); Xiaoxia DONG, Shenzhen (CN); Jun WEI, Shenzhen (CN)

(21) Appl. No.: 18/849,344

(22) PCT Filed: May 10, 2022
(86) PCT No.: PCT/CN2022/091861

§ 371 Date: Sep. 20, 2024

(51) Int. Cl. G06F 21/62; G06T 5/70; G06T 7/10

(52) U.S. Cl. CPC G06F 21/6254; G06T 5/70; G06T 7/10; G06F 2221/2141

(57) ABSTRACT

The present disclosure relates to methods and apparatus for image processing. An example method includes receiving, from an application, a request to access an image, wherein the application is enabled access to one or more categories of image content, processing the image to modify one or more portions of the image that include content not within the one or more categories, and providing, to the application, the processed image.

### BACKGROUND

### Field of the Disclosure

The present disclosure relates generally to processing systems and, more particularly, to one or more techniques for image processing and privacy control.

### Description of Related Art

Many computing devices include one or more images sensors (e.g., charge-coupled device (CCD) sensors, complementary metal oxide semiconductor (CMOS) sensors, or other camera sensors) for capturing still images and/or videos. Examples of such computing devices include dedicated digital cameras, tablets, laptops, smartphones, other mobile devices, wearables, Internet of Things devices, automotive devices, etc.

An application (e.g., a camera application, a video call application, etc.) running on a computing device may utilize an image sensor of the computing device to capture one or more images. For privacy protection purposes, in order to operate the image sensor, the application may first need to request permission from a user of the computing device to access the image sensor. For example, a user may be prompted by a dialog on the computing device to either “always allow”, “allow while in use”, or “deny” image sensor permission to the application. Explicit permission requested from a user helps to prevent the application from gaining access to private data without a user's consent, as well as provide a user with additional context and visibility into the types of permissions that applications are either seeking, or have been granted.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

In certain aspects, a method for image processing is disclosed. The method includes receiving, from an application, a request to access an image, wherein the application is enabled access to one or more categories of image content; processing the image to modify one or more portions of the image that include content not within the one or more categories; and providing, to the application, the processed image.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a computing device, a processing system, etc.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example computing device including an image sensor, in accordance with certain aspects of the present disclosure.

FIG. 2 is a block diagram illustrating an example software stack of the computing device of FIG. 1, in accordance with certain aspects of the present disclosure.

FIG. 3 is a call flow diagram illustrating example image processing, in accordance with certain aspects of the present disclosure.

FIG. 4 illustrates an example method for image processing based on content, in accordance with certain aspects of the present disclosure.

FIG. 5 illustrates an example image processing for an application requesting permission to access an image with quick response (QR) code content, in accordance with certain aspects of the present disclosure.

FIG. 6 is a flow diagram illustrating example operations for image processing, in accordance with certain aspects of the present disclosure.

### DETAILED DESCRIPTION

The present disclosure provides techniques for image processing, and more specifically, image processing based on content requested and authorized for application use.

In certain aspects, an application (e.g., a camera application, a video call application, a camera scanner application, etc.) running on a computing device may utilize an image sensor of the computing device to capture one or more images. In conventional designs, however, the application may utilize an image sensor only where runtime permission is granted to the application for use of the image sensor.

Permissions serve to protect the privacy of a user. Runtime permissions cover areas where an application running on a computing device seeks data or resources that involve a user's private information, or could potentially affect the user's stored data or the operation of other applications running on the computing device. For example, the ability of an application to access features, such as an image sensor of the computing device, may first require the application to request permission of the application to use the image sensor at runtime and a user of the device to grant such permission. Only after such permission is granted may the application issue an image sensor open call to an application programming interface (API) of an API framework to utilize an image sensor of the computing device for capturing one or more images. Permission granted to the application for image sensor use may be unlimited, in that the application may have access to all content captured by the image sensor.

While runtime permissions help to prevent the application from gaining access to features of the computing device without a user's consent, such unlimited permission granted may be excessive. In fact, an application may be seeking use of the image sensor for a particular purpose. For example, a plant recognition application may request to access an image sensor of the computing device for purposes of capturing an image of a plant for recognition (e.g., obtaining an image having a plant), while a payment application may request to access the image sensor for purposes of scanning a QR code for payment (e.g., obtaining an image having QR code content). Irrespective of their purpose for utilizing the image sensor, each application which is granted permission to use the image sensor may have access to all content contained within images captured by the image sensor, including superfluous content, which may, in some cases, include private and/or sensitive information of a user of the computing device.

Accordingly, certain aspects herein provide techniques for image processing, and more specifically, image processing based on content requested and authorized for application use. Image processing described herein may include the detection of content requested by an application in an image, as well as techniques for de-emphasizing and/or removing other superfluous information (e.g., information not requested by the application) present in the image. Removal of the unnecessary information may allow for improved privacy control by eliminating such unnecessary information in an image prior to providing the image to one or more applications for use. Improved user privacy protection provided by techniques described herein may help to improve overall user experience when using the computing device.

Various aspects of systems, apparatuses, computer program products, and methods are described more fully hereinafter for image processing. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method, which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different graphics technologies, system configurations, etc., some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs, central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

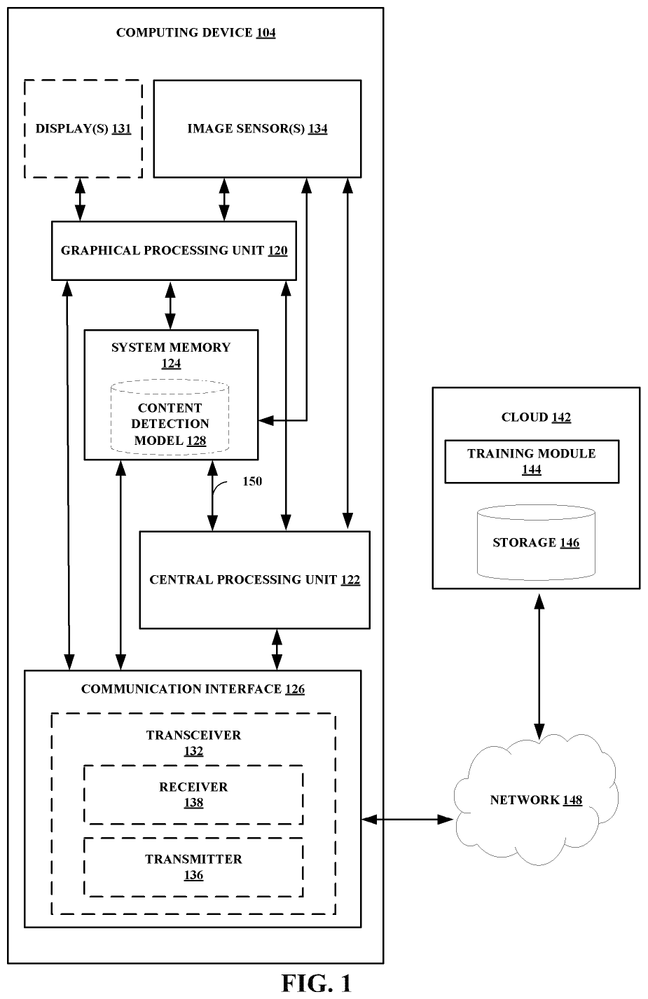

FIG. 1 is a block diagram that illustrates an example computing device 104 configured to implement one or more techniques of this disclosure. Computing device 104 may include one or more components or circuits for performing various functions described herein. In some examples, one or more components of computing device 104 may be components of a system on a chip (SOC) or integrated circuit (IC). Computing device 104 may include one or more components configured to perform one or more techniques of this disclosure. In the example shown, computing device 104 may include a GPU 120, a CPU 122, a system memory 124, and one or more image sensors 134 (e.g., CCD sensors, CMOS sensors, etc.). In some aspects, computing device 104 can include a number of optional components, for example, a communication interface 126, a transceiver 132 (e.g., including a receiver 138 and a transmitter 136), and one or more displays 131. In certain aspects, the components are communicatively connected to one another by one or more buses 150. It should be noted that though certain connections are shown between components in FIG. 1, the connections between components may be different than shown. For example, all components may be coupled to a shared bus 150, different components may be coupled to different buses, etc.

Reference to display 131 may refer to one or more displays 131. For example, display 131 may include a single display or multiple displays. GPU 120 may be configured to perform graphics processing. The one or more displays 131 may be configured to display or otherwise present frames processed by GPU 120 and/or CPU 122. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the GPU 120 and the CPU 122, such as system memory 124 (described in more detail below), may be accessible to the GPU 120 and the CPU 122. For example, GPU 120 and CPU 122 may be configured to read from and/or write to external memory, such as the system memory 124. GPU 120 and CPU 122 may be communicatively coupled to system memory 124 over a bus. In some examples, GPU 120 and CPU 122 may be communicatively coupled to each other over the bus or a different connection.

In certain aspects, CPU 122 and/or GPU 120 may be configured to receive images (e.g., still images, video, etc.) from one or more image sensors 134. For example, CPU 122 and/or GPU 120 may be configured to receive images directly from one or more image sensors 134. In certain aspects, the one or more image sensors 134 may be configured to write images to external memory, such as the system memory 124. In certain aspects, CPU 122 and/or GPU 120 may be configured to receive (e.g., read) the images from system memory 124.

GPU 120 may be a general purpose GPU, or any other processing unit that may be configured to perform graphics processing. In some examples, GPU 120 may be integrated into a motherboard of device 104. In some examples, GPU 120 may be present on a graphics card that is installed in a port in a motherboard of device 104, or may be otherwise incorporated within a peripheral device configured to interoperate with the device 104. GPU 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, GPU 120 may store instructions for the software in a suitable, non-transitory computer-readable storage medium, e.g., system memory 124, and may execute the instructions in hardware using one or more processors to perform the techniques of this disclosure. Any of the foregoing, including hardware, software, a combination of hardware and software, etc., may be considered to be one or more processors.

CPU 122 may be any processing unit configured to send instructions to GPU 120 and perform general computational processing (e.g., non-graphical processing). In some examples, CPU 122 may be integrated into a motherboard of device 104. CPU 122 may include one or more processors, such as one or more microprocessors, ASICs, FPGAs, ALUs, DSPs, video processors, discrete logic, software, hardware, firmware, other equivalent integrated or discrete logic circuitry, or any combinations thereof. If the techniques are implemented partially in software, CPU 122 may store instructions for the software in a suitable, non-transitory computer-readable storage medium, e.g., system memory 124, and may execute the instructions in hardware using one or more processors to perform the techniques of this disclosure. Any of the foregoing, including hardware, software, a combination of hardware and software, etc., may be considered to be one or more processors.

System memory 124 may include one or more volatile or non-volatile memories or storage devices. In some examples, system memory 124 may include RAM, static RAM (SRAM), dynamic RAM (DRAM), erasable programmable ROM (EPROM), EEPROM, flash memory, a magnetic data media or an optical storage media, or any other type of memory.

System memory 124 may be a non-transitory storage medium according to some examples. The term “non-transitory” may indicate that the storage medium is not embodied in a carrier wave or a propagated signal. However, the term “non-transitory” should not be interpreted to mean that system memory 124 is non-movable or that its contents are static. As one example, system memory 124 may be removed from device 104 and moved to another device. As another example, system memory 124 may not be removable from the device 104.

In certain aspects, system memory 124 may contain one or more content detection models 128 (e.g., individually referred to herein as content detection model 128 and collectively referred to herein as content detection models 128). Content detection model 128 may be an artificial intelligence (AI) model, such as a machine-learning model, capable of detecting one or more content categories in still images, video, etc. from one or more image sensors 134. The one or more content categories may include a QR code, an identification (ID) image, a plant, a file, a person, a place, a figure, and/or the like.

In certain aspects, one content detection model 128 may be stored in system memory 124, where content detection model 128 is an AI model trained to detect multiple content categories (e.g., trained to detect a QR code, an ID image, a plant, a file, etc. in images). In certain other aspects, multiple content detection models 128 may be stored in system memory 124, where each content detection model 128 is an AI model trained to detect a particular category of content (e.g., a first content detection model 128 is trained to detect a QR code in images, a second content detection model 128 is trained to detect a an ID image in images, a third content detection model 128 is trained to detect a plant in images, etc.).

Content detection model 128 may be trained using training data, which may include data associated with one or more images. More specifically, data associated with one or more images may be used as input (e.g., training data) for training a model to predict (e.g., detect) the coordinates of at least one content category within the one or more images.

In certain aspects, content detection model 128 may be trained only at a cloud 142, where cloud 142 may be a public or private cloud. In particular, content detection model 128 may be trained at cloud 142 via training module 144, and after such training, may be deployed at computing device 104 for detecting one or more categories of image content. Where content detection model 128 is trained at cloud 142, training data may be stored in storage 146 and used as input, by training module 144, for training content detection model 128. Storage 146 may be implemented as any type of datastore, such as relational databases, non-relational databases, key-value datastores, file systems including hierarchical file systems, and the like. In certain aspects, content detection model 128 may be trained only at computing device 104 (and cloud 142 may not be involved). In certain aspects, content detection model 128 may be trained (initially and/or updated) at both computing device 104 and cloud 142. In certain aspects, training of content detection model 128 may be federated such that training happens at different computing devices 104. Each different computing device 104 may send updates to cloud 142, which may be aggregated by cloud 142 to update model parameters for content detection model(s) 128 on each computing device 104. Cloud 142 may then send updated model parameters for content detection model(s) 128 on each computing device 104 to each computing device 104.

In certain aspects, a list of content categories which content detection model(s) 128 is capable of detecting may be stored in a file in system memory 124 and/or in storage on computing device 104 (e.g., not shown in FIG. 1). The content categories may change as new content detection models 128 are created and trained to detect a content category for which existing content detection models 128 are not capable of detecting, existing content detection models 128 are updated to detect a content category for which the existing content detection models 128 are not capable of detecting, and/or existing content detection models 128 are updated such that the existing content detection models 128 are no longer capable of detecting a previously detectable content category. An application requesting to access image sensor 134 for purposes of obtaining an image may choose a content category from the list of content categories.

The content categories may include, for example, a QR code, an ID image, a plant, a file, a person, a place, a figure, and/or the like. For example, a payment application may request to access image sensor 134 for purposes of scanning a QR code for payment (e.g., obtaining an image having QR code content) where at least one content detection model 128 is capable of detecting portion(s) of image(s) containing QR code content. As another example, a banking application may request to access image sensor 134 for purposes of scanning an ID image for registration (e.g., obtaining an image having ID image content) where at least one content detection model 128 is capable of detecting portion(s) of image(s) containing ID image content. As another example, a plant recognition application may request to access image sensor 134 for purposes of capturing an image of a plant for recognition (e.g., obtaining an image having a plant) where at least one content detection model 128 is capable of detecting portion(s) of image(s) containing plant content.

In certain aspects, computing device 104 can include an optional communication interface 126. Computing device 104 may use communication interface 126 to communicate with cloud 142, connected by a network 148. Network 148 may be, for example, a direct link, a local area network (LAN), a wide area network (WAN) such as the Internet, another type of network, or any combination thereof.

Communication interface 126 may include a receiver 138 and a transmitter 136. Receiver 138 may be configured to perform any receiving function described herein with respect to computing device 104. Additionally, receiver 138 may be configured to receive information from another device (or cloud 142). Transmitter 136 may be configured to perform any transmitting function described herein with respect to the computing device 104. For example, transmitter 136 may be configured to transmit information to another device (e.g., such as cloud 142). Receiver 138 and transmitter 136 may be combined into a transceiver 132. In such examples, transceiver 132 may be configured to perform any receiving function and/or transmitting function described herein with respect to computing device 104.

CPU 122 may be configured to run content detection model 128. In certain aspects, CPU 122 may be configured to run content detection model 128 to detect one or more portions of image content that include a particular content category (e.g., detect portions of a still image which include a QR code). In certain aspects, CPU 122 may be configured to run content detection model 128 to detect one or more portions of one or more images that do not include a particular content category (e.g., detect portions of a still image which do not include a QR code). In certain aspects, CPU 122 may be configured to run content detection model 128 to detect one or more portions of one or more images that include and/or do not include a particular content category. In certain aspects, another processor, such as a dedicated neural processor, may be configured to run content detection model 128 for purposes of detecting one or more portions of one or more images that include and/or do not include a particular content category.

As described in more detail below, CPU 122 may use the detected portions of one or more images that include a particular content category to process remaining portions of the image for privacy purposes. For example, based on detecting a QR code in a still image, CPU 122 may process other portions of the image, aside from the portion of the image including the QR code, to obscure (e.g., blur, remove, mask, etc.) the remaining portions of the image. In another example, CPU 122 may use the detected portions of the image that do not include a particular content category to process such portions of the image for privacy purposes. For example, based on detecting portions within a still image that do not contain QR code content (e.g., the background area and/or other figures of a still image), CPU 122 may process such portions to obscure content within these portions of the image. In either example, such obscuring may allow for the QR code to remain visible while keeping other content in the still image from being visible (e.g., by an application).

In certain aspects, CPU 122 may be configured to pass the processed image to an application running on computing device 104 that requested the image. Transferring a processed image to the application, as opposed to a raw image captured by image sensor 134, may provide the application with the necessary information requested by the application, without providing unnecessary and/or private information (e.g., of a user using computing device 104) to the application.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular hardware component (e.g., a GPU), but, in further embodiments, can be performed using other hardware components (e.g., a CPU), consistent with disclosed embodiments.

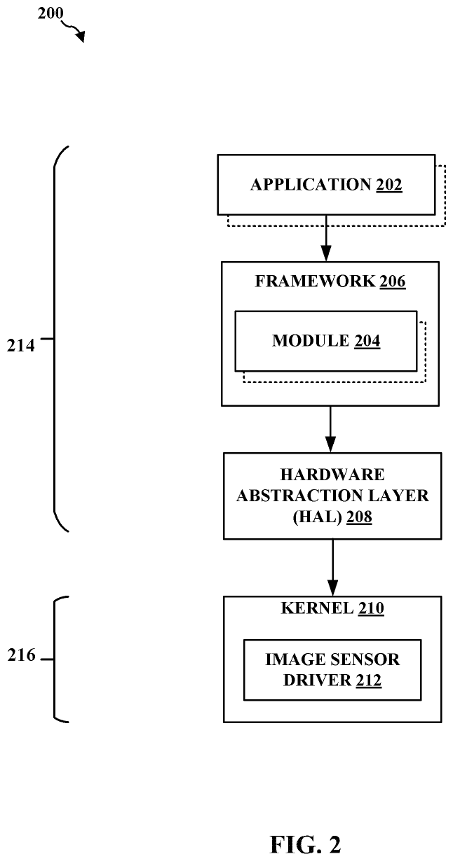

FIG. 2 is a block diagram illustrating an example software stack 200 executing on computing device 104 of FIG. 1. It should be noted that software stack 200 could also execute on other suitable computing devices. Further, in certain aspects, computing device 104 may execute other similar software, including fewer or additional components, to perform the techniques discussed herein. For example, the functionality of one or more components discussed may be combined in a single component, or may be divided into additional components. In certain aspects, code for software stack 200 may be stored in memory, such as system memory 124 of computing device 104. Further, in certain aspects, software stack 200 may be executed by one or more processors, such as CPU 122 of computing device 104.

As shown, software stack 200 includes one or more applications 202 (individually referred to herein as application 202 and collectively referred to herein as applications 202), a framework 206 (e.g., Android framework) including one or more modules 204 (individually referred to herein as module 204 and collectively referred to herein as modules 204) a hardware abstraction layer (HAL) 208, and a kernel 210 (e.g., Linux kernel for Android) including an image sensor driver 212. In certain aspects, one or more applications 202, framework 206 including one or more modules 204, and/or HAL 208 run in user space 214, meaning they have access to memory and/or resources defined as accessible within user space 214, which may be less than a number of memory and/or resources defined as accessible within kernel space 216. In certain aspects, the kernel 210 runs in kernel space 216.

In certain aspects, the one or more applications 202 may utilize the one or more image sensors 134 of computing device 104 to capture one or more images (e.g., still images, video, etc.). For example, one or more applications 202 may include one or more of a camera app, a video call app, or the like.

In certain aspects, framework 206 is an API framework that provides APIs (e.g., a set of Java framework APIs) that expose the functionality of native libraries, system components, and/or services to applications, such as application 202. For example, framework 206 provides APIs to expose the functionality of one or more image sensors 134 to application 202, such as the camera function.

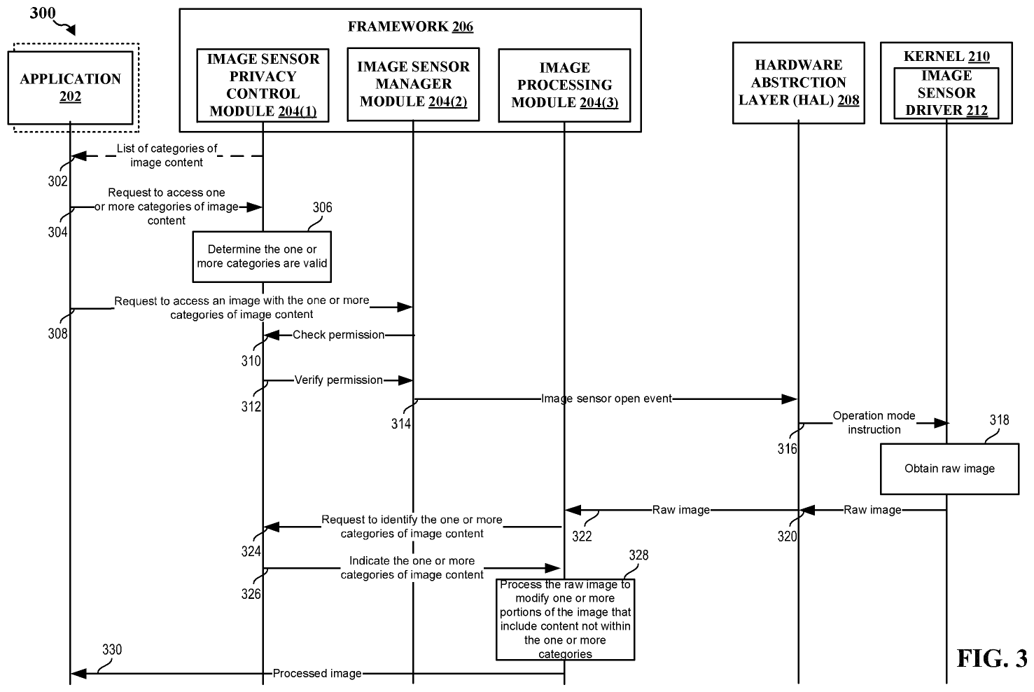

In certain aspects, framework 206 includes one or more modules 204, such as an image sensor privacy control module 204(1), an image sensor manager module 204(2), and an image processing module 204(3) (e.g., illustrated in FIG. 3).

Image sensor privacy control module 204(1) may be configured to manage permissions of an application 202 with respect to image sensor(s) 134 (e.g., illustrated in FIG. 1). For example, image sensor privacy control module 204(1) may (1) determine whether a content category requested by an application 202 is a content category for which content detection model(s) 128 is capable of detecting and (2) verify a user has granted the application authorization to access this particular content category of one or more images.

Image sensor manager module 204(2) may act as a gateway between application 202 and image sensor 134. In certain aspects, image sensor manager module 204(2) may communicate with image sensor privacy control module 204(1) to determine whether an application requesting a particular content category, in fact has permission to access this content category.

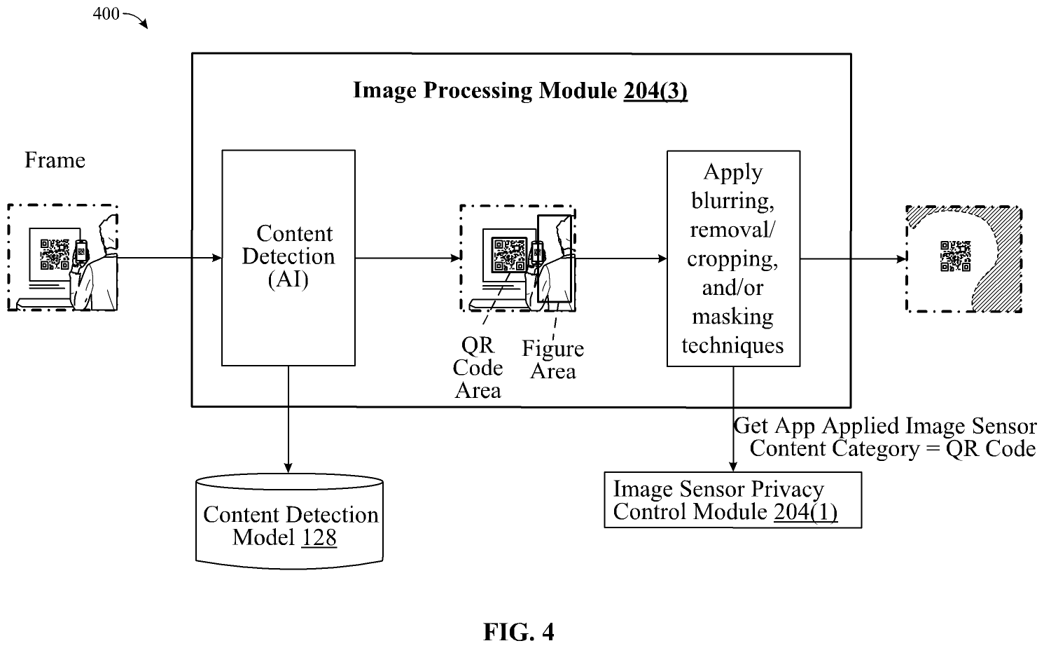

Image processing module 204(3) may be configured to (1) receive one or more raw images from image sensor 134 and (2) process the one or more raw images to modify portions of the one or more raw images that include content not within a content category for which an application 202 has requested and has permission to access. As described in more detail below with respect to FIG. 4, processing one or more raw images may involve using content detection model(s) 128 to detect portions of the one or more images that include content not within a content category requested or portions of the one or more raw images that includes content within the content category requested. Further, processing may include obscuring portions of the one or more raw images that do not include content within the content category requested.

Operations performed by image sensor privacy control module 204(1), image sensor manager module 204(2), and image processing module 204(3) may be described in more detail below with respect to FIG. 3. Further, it should be noted that though aspects are described herein with respect the use of these three modules, in certain other aspects, the operations performed by each of these modules may be performed by a single module or different modules implemented in software stack 200.

In certain aspects, HAL 208 provides standard interfaces that expose device hardware capabilities to framework 206. For example, in certain aspects, HAL 208 includes library modules, which implement an interface for hardware components, such as one or more image sensors 134. In certain aspects, when framework 206 makes a call to access a hardware component, HAL 208 loads the library module for the hardware component. For example, when framework 206 issues an image sensor open call to access one or more image sensors 134 (e.g., for obtaining a raw image), HAL 208 communicates with the image sensor driver 212 in kernel 208 as discussed further herein.

In certain aspects, kernel 210 interfaces with hardware components, such as adjusting an operation mode (e.g., operating frequency and/or voltage) of one or more components (e.g., CPU 122, GPU 120, and/or bus 150). In certain aspects, kernel 2010 includes one or more drivers, each driver for interfacing with a particular hardware component. For example, kernel 210 includes image sensor driver 212 for interfacing with one or more image sensors 134.

In certain aspects, application 202 may issue an image sensor open call to an API of framework 206 to utilize an image sensor to obtain one or more images. The call may be a request to access one or more content categories contained within an image (e.g., captured using image sensor 134 or retrieved from storage). The image sensor open call may be handled based on the one or more content categories requested by application 202 according to the techniques discussed herein.

FIG. 3 is a call flow diagram 300 illustrating example image processing, in accordance with certain aspects of the present disclosure. Call flow diagram 300 is described with respect to software stack 200. However, it should be understood that call flow diagram 300, or techniques similar thereto, may be performed by any suitable software running on any suitable computing device.

At operation 304, application 202 sends a request to access one or more categories of image content. For example, application 202 may issue a call to an API of framework 206, and more specifically image sensor privacy control module 204(1), to access one or more categories of image content. As an illustrative example, as mentioned previously, application 202 may be a payment application and at operation 304 may send a request to image sensor privacy control module 204(1) to access QR code content within an image for purposes of scanning the QR code for payment.

In certain aspects, prior to operation 304, at operation 302, image sensor privacy control module 204(1) transmits a list of content categories to application 202. Image sensor privacy control module 204(1) may transmit this list to application 202 in response to a request from application 202 and/or another trigger, periodically, as new content categories become available, as content categories are removed from the list, etc. As mentioned, the list transmitted to application 202 may be a list of content categories which content detection model(s) 128 is capable of detecting. Accordingly, application 202 may choose one or more content categories from the list and provide in its API call to image sensor privacy control module 204(1) an indication of the selected one or more content categories for which application 202 is requesting to access.

At operation 306, based on receiving the request from application 202, image sensor privacy control module 204(1) determines whether the one or more content categories requested by application 202 are valid content categories. In other words, image sensor privacy control module 204(1) determines whether the one or more content categories are categories within the list of content categories for which content detection model(s) 128 is capable of detecting. For example, where application 202 requests to access an image having a QR code, at operation 306, image sensor privacy control module 204(1) checks whether QR code content is a content category which content detection model(s) 128 is capable of detecting. For purposes of explanation, it may be assumed that the content category requested by application 202 is a content category for which content detection model(s) 128 is capable of detecting.

Further, at operation 306, based on receiving the request from application 202, image sensor privacy control module 204(1) determines whether a user has granted application 202 permission to access the requested one or more categories of image content. In some cases, this determination may involve image sensor privacy control module 204(1) prompting a user to grant permission to application 202 to access the requested one or more categories of image content. Prompting a user to grant permission may, for example, involve prompting a user to grant permission via a dialog (e.g., pop-up) on computing device 104 to either “always allow”, “allow while in use”, or “deny” application 202 permission to the requested one or more categories of image content.

At operation 308, application 202 sends a request to access an image with the one or more categories of image content. For example, application 202 may issue an image sensor open call to an API of framework 206, and more specifically to image sensor manager module 204(2), to obtain an image (e.g., to be captured or previously captured by image sensor 134) having the one or more categories of image content.

Based on receiving the image sensor open call, image sensor manager module 204(2) determines whether application 202 has permission to access an image with the requested one or more categories of image content. As such, at operations 310 and 312, image sensor manager module 204(2) communicates with image sensor privacy control module 204(1) (e.g., which has knowledge about application 202's permission) to determine whether application 202 has been granted permission. For purposes of explanation, it may be assumed that application 202 is authorized to access an image with the requested one or more categories of image content.

At operation 314, based on image sensor privacy control module 204(1) verifying permission of application 202 at operation 312, image sensor manager module 204(2) issues an image sensor open event to HAL 208. Accordingly, at operation 316, based on receiving the image sensor open event, HAL 208 issues an operation mode instruction to kernel 210 (e.g., to image sensor driver 212). In certain aspects, the operation mode instruction comprises an instruction to capture an image using image sensor 134. In certain aspects, the operation mode instruction comprises an instruction to retrieve an image from storage. The captured or retrieved image may be a raw image which contains minimally processed data (or data which has not been processed) from image sensor 134. The term “raw” may refer to not being processed to remove content not in the one or more categories, but in some aspects, other image processing may have been performed.

At operation 320, the raw image may be transferred from kernel 210 to HAL 208 and subsequently, at operation 322, transferred from HAL 208 to an API of framework 206, and more specifically, to image processing module 204(3). As mentioned previously, image processing module 204(3) processes raw images to modify portions of the raw images that include content not within a content category for which an application 202 has requested and has permission to access. Accordingly, prior to processing the raw image received at operation 322, at operation 324 image processing module 204(3) may request image sensor privacy control module 204(1) to identify the one or more categories of image content for which application 202 is requesting access. At operation 326, in response to the request received from image processing module 204(3), image sensor privacy control module 204(1) may indicate, to image processing module 204(3), the one or more categories of image content requested by application 202. The indication may also relay to image processing module 204(3) that application 202 has permission to access such content categories and/or such content categories are valid content categories (e.g., are content categories for which content detection model(s) 128 is capable of detecting).

At operation 328, image processing module 204(3) processes the raw image to modify one or more portions of the image that include content not within the one or more categories (e.g., categories requested by application 202 which application 202 has permission to access and are valid categories). Processing, at operation 328, by image processing module 204(3) may be better understood with reference to FIG. 4.

FIG. 4 illustrates an example method 400 for image processing based on content, in accordance with certain aspects of the present disclosure. As shown in FIG. 4, similar to operation 322 of FIG. 3, image processing module 204(3) may receive a raw image from HAL 208. As a first step, content detection model(s) 128 running on a processor (e.g., CPU 122 in FIG. 1, or another processor, such as a neural processor) may use as input into content detection model(s) 128, the raw image received at image processing module 204(3) to detect one or more content categories within the raw image. As shown in FIG. 4, the raw image may contain a QR code and a figure (e.g., person), and content detection model(s) 128 may be used to predict (e.g., detect) the coordinates of at least one of the QR code or the figure.

After detection of the QR code and the figure in the raw image, as a second step, similar to operations 324 and 326 illustrated in FIG. 3, image processing module 204(3) may request image sensor privacy control module 204(1) to identify the one or more categories of image content for which application 202 is requesting access, and, in response to the request received from image processing module 204(3), image sensor privacy control module 204(1) may indicate, to image processing module 204(3), the one or more categories of image content requested by application 202.

Although FIG. 3 illustrates such a request/response happening prior to processing (e.g., prior to at least using content detection model(s) 128 for detecting one or more content categories in the raw image), in certain aspects, for example as shown in FIG. 4, the request/response may occur after content detection model(s) 128 is used to detect one or more content categories in the raw image. Where the request/response occurs after use of content detection model(s) 128, content detection model(s) 128 may detect all content in the raw image for which they are configured to detect. On the other hand, in certain aspects, where the request/response occurs prior to use of content detection model(s) 128, content detection model(s) 128 may be configured to detect (1) only portions of the image that include content not within the one or more categories indicated in the response or (2) only portions of the image that include content within the one or more categories indicated in the response. In certain other aspects, where the request/response occurs prior to use of content detection model(s) 128, content detection model(s) 128 may be configured to detect (1) at least portions of the image that include content not within the one or more categories indicated in the response or (2) at least portions of the image that include content within the one or more categories indicated in the response.

In response to receiving the indication of the one or more categories of image content requested by application 202, image processing module 204(3) may be configured to process the raw image by obscuring one or more portions of the raw image which contain content that was not requested by application 202. For example, as shown in FIG. 4, in response to receiving an indication that application 202 requested QR code content, image processing module 204(3) may be configured to obscure portions of the raw image not including the QR code content. In certain aspects, image processing module 204(3) may blur portions of the raw image not including the QR code content, remove/crop portions of the raw image not including the QR code content, and/or mask (e.g., color fill) portions of the raw image not including the QR code content. Other similar techniques for obscuring the portions of the raw image not including the QR code content may also be used by image processing module 204(3) to protect the privacy of other content in the image prior to providing the image to application 202.

Returning back to FIG. 3, after processing the raw image to create a processed image, the processed image may be returned to application 202 which made the initial request. Visible content in the processed image may include image content which application 202 requested. According to aspects described herein, other content within the processed image may be obscured.

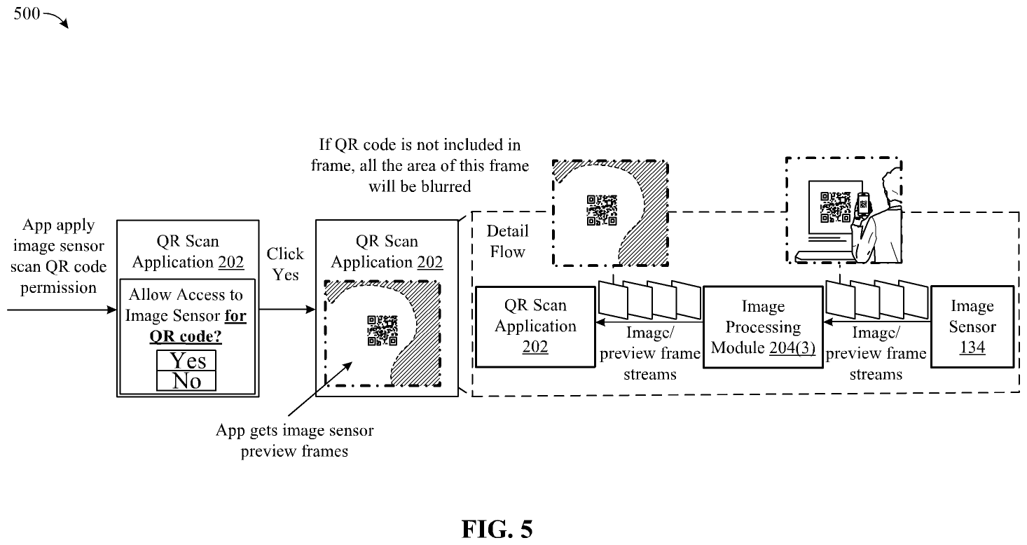

FIG. 5 illustrates an example 500 of image processing for an application requesting permission to access an image with QR code content, in accordance with certain aspects of the present disclosure.

As shown in FIG. 5, a QR scan application 202 may issue a camera open call to an API of framework 206 to utilize an image sensor 134 to capture one or more images having QR code content. Accordingly, framework 206 may issue a camera open event to HAL 208. HAL 208 may load library modules for image sensor 134, and issue instructions to kernel 210 and image sensor driver 212 to start a camera session, including allocating resources to image sensor 134 and/or application 202, such as: memory resources of system memory 124 for buffering or storing images captured by the image sensor 134, bus resources of bus 150 for moving data between components such as CPU 122, GPU 120, and/or system memory 124, and/or processor resources of CPU 122 and/or GPU 120 for running processes/library modules that support operation of image sensor 134.

Image sensor 134 may capture an image containing QR code content and pass the raw image to image processing module 204(3). As described in detail with respect to FIG. 4, image processing module 204(3) may process the raw image to modify portions of the raw image that do not include QR code content. In other words, image processing module 204(3) may use content detection model(s) 128 to either (1) detect all content within the raw image for which content detection model(s) 128 is configured to detect, (2) detect portions of the raw image that include QR code content, and/or (3) detect portions of the raw image that do not include QR code content. Further, processing may include obscuring portions of the raw image that do not include QR code content.

Although FIG. 5 illustrates QR code content within the captured image, in some other cases, the requested content may not be within the raw image and/or may not be able to be detected by content detection model(s) 128. In such a case, the entire image may be obscured (e.g., the entire image may be blurred).

After processing, the processed image may be provided to QR scan application 202 for use. As shown in FIG. 5, the processed image may include QR code content while the figure, which was present in the raw image, is blurred for purpose of privacy protection.

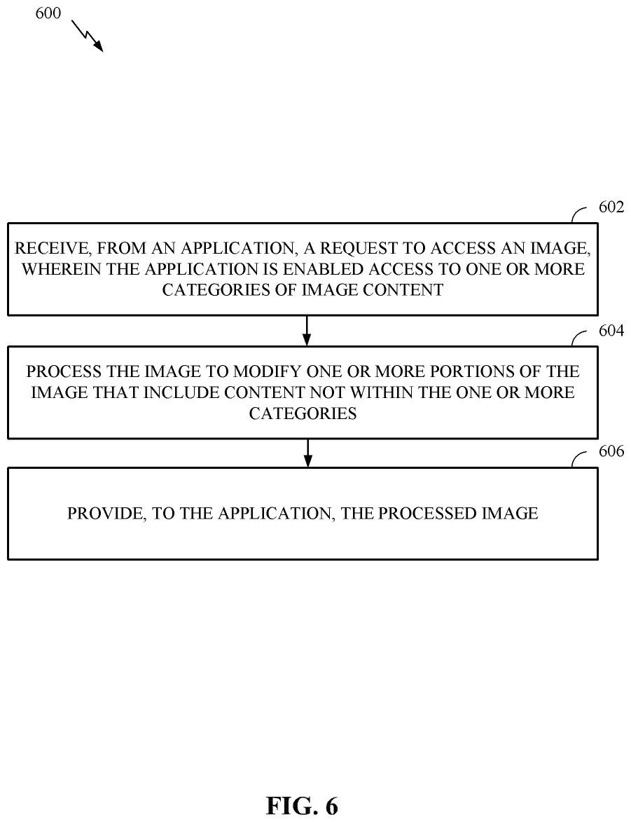

FIG. 6 is a flow diagram illustrating example operations 600 for image processing, in accordance with certain aspects of the present disclosure.

Operations 600 may be performed, for example, by a computing device (e.g., computing device 104 of FIG. 1). Operations 600 may be implemented as software components (e.g., software stack 200) that are executed and run on one or more processors (e.g., CPU 122 or GPU 120 of FIG. 1, or another processor).

Operations 600 may begin, at a first block 602, by receiving, from an application, a request to access an image, wherein the application is enabled access to one or more categories of image content.

Operations 600 may continue, at a second block 604, by processing the image to modify one or more portions of the image that include content not within the one or more categories.

Operations 600 may continue, at a third block 606, by providing, to the application, the processed image.

In certain aspects, operations 600 further include at least one of: capturing the image using an image sensor or retrieving the image from a storage.

In certain aspects, operations 600 further include receiving, from the application, a request for permission to access the one or more categories of image content. In certain aspects, operations 600 further include prompting a user to grant the permission to access the one or more categories of image content. In certain aspects, operations 600 further include providing a list of a plurality of categories of image content to the application.

In certain aspects of operations 600, the one or more categories comprise one or more of: a QR code, an ID image, a plant, or a file.

In certain aspects of operations 600, processing the image to modify the one or more portions comprises obscuring the one or more portions. In certain aspects of operations 600, obscuring the one or more portions comprises at least one of: blurring the one or more portions, removing the one or more portions, or masking the one or more portions.

In certain aspects of operations 600, processing the image to modify the one or more portions comprises: detecting at least one of the one or more portions of the image that include content not within the one or more categories or at least one portion of the image that includes content within the one or more categories. In certain aspects of operations 600, detecting is performed using an object detection artificial intelligence model.

### Example Clauses

Implementation examples are described in the following numbered clauses:

Clause 1. A method for image processing, the method comprising: receiving, from an application, a request to access an image, wherein the application is enabled access to one or more categories of image content; processing the image to modify one or more portions of the image that include content not within the one or more categories; and providing, to the application, the processed image.

Clause 2. The method of Clause 1, further comprising at least one of: capturing the image using an image sensor; or retrieving the image from a storage.

Clause 3. The method of any of Clauses 1 or 2, further comprising: receiving, from the application, a request for the permission to access the one or more categories of image content.

Clause 4. The method of Clause 3, further comprising: prompting a user to grant the permission to access the one or more categories of image content.

Clause 5. The method of any of Clauses 3 or 4, further comprising: providing a list of a plurality of categories of image content to the application.

Clause 6. The method of any of Clauses 1-5, wherein processing the image to modify the one or more portions comprises obscuring the one or more portions.

Clause 7. The method of Clause 6, wherein obscuring the one or more portions comprises at least one of: blurring the one or more portions; removing the one or more portions; or masking the one or more portions.

Clause 8. The method of any of Clauses 1-7, wherein processing the image to modify the one or more portions comprises: detecting at least one of the one or more portions of the image that include content not within the one or more categories or at least one portion of the image that includes content within the one or more categories.

Clause 9. The method of Clause 8, wherein the detecting is performed using an object detection artificial intelligence model.

Clause 10. An apparatus, comprising: a memory comprising executable instructions; and a processor configured to execute the executable instructions and cause the apparatus to perform a method in accordance with any one of Clauses 1-9.

Clause 11. An apparatus, comprising means for performing a method in accordance with any one of Clauses 1-9.

Clause 12. A non-transitory computer-readable medium comprising executable instructions that, when executed by a processor of an apparatus, cause the apparatus to perform a method in accordance with any one of Clauses 1-9.

Clause 13. A computer program product embodied on a computer-readable storage medium comprising code for performing a method in accordance with any one of Clauses 1-9.

### Additional Considerations

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method for image processing, the method comprising:
receiving, from an application, a request to access an image, wherein the application is enabled access to one or more categories of image content;
processing the image to modify one or more portions of the image that include content not within the one or more categories; and
providing, to the application, the processed image.

2. The method of claim 1, further comprising at least one of:
capturing the image using an image sensor; or
retrieving the image from a storage.

3. The method of claim 1, further comprising:
receiving, from the application, a request for permission to access the one or more categories of image content.

4. The method of claim 3, further comprising:
prompting a user to grant the permission to access the one or more categories of image content.

5. The method of claim 3, further comprising:
providing a list of a plurality of categories of image content to the application.

6. The method of claim 1, wherein processing the image to modify the one or more portions comprises obscuring the one or more portions.

7. The method of claim 6, wherein obscuring the one or more portions comprises at least one of:
blurring the one or more portions;
removing the one or more portions; or
masking the one or more portions.

8. The method of claim 1, wherein processing the image to modify the one or more portions comprises:
detecting at least one of the one or more portions of the image that include content not within the one or more categories or at least one portion of the image that includes content within the one or more categories.

9. The method of claim 8, wherein the detecting is performed using an object detection artificial intelligence model.

10. A computing device comprising:
a memory; and
a processor configured to cause the computing device to:
receive, from an application running on the computing device, a request to access an image, wherein the application is enabled access to one or more categories of image content;
process the image to modify one or more portions of the image that include content not within the one or more categories; and
provide, to the application, the processed image.

11. The computing device of claim 10, wherein the computing device further comprises an image sensor; and
the processor is further configured to cause the computing device to at least one of:
capture the image using the image sensor; or
retrieve the image from a storage.

12. The computing device of claim 10, wherein the processor is further configured to cause the computing device to:
receive, from the application, a request for permission to access the one or more categories of image content.

13. The computing device of claim 12, wherein the processor is further configured to cause the computing device to:
prompt a user to grant the permission to access the one or more categories of image content.

14. The computing device of claim 12, wherein the processor is further configured to cause the computing device to:
provide a list of a plurality of categories of image content to the application.

15. The computing device of claim 10, wherein the processor is configured to cause the computing device to process the image to modify the one or more portions by obscuring the one or more portions.

16. The computing device of claim 15, wherein the processor is configured to cause the computing device to obscure the one or more portions by at least one of:
blurring the one or more portions;
removing the one or more portions; or
masking the one or more portions.

17. The computing device of claim 10, wherein the processor is configured to cause the computing device to process the image to modify the one or more portions by:
detecting at least one of the one or more portions of the image that include content not within the one or more categories or at least one portion of the image that includes content within the one or more categories.

18. The computing device of claim 17, wherein the detecting is performed using an object detection artificial intelligence model.

19. A computing device comprising:
means for receiving, from an application running on the computing device, a request to access an image, wherein the application has permission to access one or more categories of image content;
means for processing the image to modify one or more portions of the image that include content not within the one or more categories; and
means for providing, to the application, the processed image.

20. The computing device of claim 19, further comprising at least one of:
means for capturing the image using an image sensor; or
means for retrieving the image from a storage.

21. The computing device of claim 19, further comprising:
means for receiving, from the application, a request for the permission to access the one or more categories of image content.

22. The computing device of claim 21, further comprising:
means for prompting a user to grant the permission to access the one or more categories of image content.

23. The computing device of claim 19, wherein the means for processing the image to modify the one or more portions comprises means for obscuring the one or more portions.

24. The computing device of claim 19, wherein the means for processing the image to modify the one or more portions comprises:
means for detecting at least one of the one or more portions of the image that include content not within the one or more categories or at least one portion of the image that includes content within the one or more categories.

25. A non-transitory computer readable medium storing instructions that, when executed by a computing device, cause the computing device to perform operations for image processing, the operations comprising:
receiving, from an application running on the computing device, a request to access an image, wherein the application has permission to access one or more categories of image content;
processing the image to modify one or more portions of the image that include content not within the one or more categories; and
providing, to the application, the processed image.

26. The non-transitory computer readable medium of claim 25, wherein the operations further comprise at least one of:
capturing the image using an image sensor; or
retrieving the image from a storage.

27. The non-transitory computer readable medium of claim 25, further comprising:
receiving, from the application, a request for the permission to access the one or more categories of image content.

28. The non-transitory computer readable medium of claim 27, wherein the operations further comprise:
prompting a user to grant the permission to access the one or more categories of image content.

29. The non-transitory computer readable medium of claim 25, wherein processing the image to modify the one or more portions comprises obscuring the one or more portions.

30. The non-transitory computer readable medium of claim 25, wherein processing the image to modify the one or more portions comprises:
detecting at least one of the one or more portions of the image that include content not within the one or more categories or at least one portion of the image that includes content within the one or more categories.
